(19) United States
(12) Patent Application Publication
(10) Pub. No.: US 2024/0388837 A1
(43) Pub. Date: Nov. 21, 2024

(54) LOUDSPEAKER

(71) Applicant: SHENZHEN WANHONG APPLE ELECTRONICSCO., LTD, Longgang District, Shenzhen, Guangdong (CN)

(72) Inventor: Xinde Chen, Longgang District, Shenzhen, Guangdong (CN)

(73) Assignee: SHENZHEN WANHONG APPLE ELECTRONICSCO., LTD, Longgang District, Shenzhen, Guangdong, OT (CN)

(21) Appl. No.: 18/690,219

(22) PCT Filed: Sep. 5, 2022
(86) PCT No.: PCT/CN2022/117134

§ 371 Date: Mar. 7, 2024

(30) Foreign Application Priority Data
Sep. 8, 2021 (CN) 202111049674.7

(51) Int. Cl. H04R 1/28; H04R 7/04; H04R 7/12; H04R 7/18; H04R 9/02; H04R 9/06

(52) U.S. Cl. CPC H04R 1/2834; H04R 7/04; H04R 7/12; H04R 7/18; H04R 9/025; H04R 9/06

(57) ABSTRACT

Disclosed is a loudspeaker, including a support, a vibration system and a magnetic circuit assembly. The vibration system includes a diaphragm, a passive diaphragm and a voice coil. The magnetic circuit assembly includes an inner magnetic ring and an outer magnetic ring. The periphery of the diaphragm is fixed at the top of the support. The voice coil is suspended below the diaphragm and located in a magnetic gap between the inner magnetic ring and the outer magnetic ring. A space between the diaphragm and the magnetic circuit assembly forms a vibration cavity. The support has an annular structure. The periphery of the passive diaphragm is fixed at the bottom of the support. A space between the passive diaphragm and the magnetic circuit assembly forms a resonance cavity. The magnetic circuit assembly includes a via hole, and the resonance cavity is connected with the vibration cavity through the via hole.

### TECHNICAL FIELD

The present invention relates to electroacoustic devices, in particular to a loudspeaker.

### BACKGROUND OF THE INVENTION

The structural quality of a loudspeaker determines its sound quality. The utility model patent No. CN202021319275.9 discloses a loudspeaker and a sound box. The loudspeaker includes a vibration system and a magnetic circuit system, the vibration system includes a diaphragm, the magnetic circuit system includes a magnet, and the loudspeaker further includes a diaphragm support disposed on the magnet and located between the diaphragm and the magnet; there is a gap between the diaphragm support and the diaphragm; when the diaphragm is pressed, the diaphragm support abuts against the diaphragm. The single diaphragm of the utility model cannot simultaneously simulate the low-frequency direct transmission and reflection delay in a natural sound field, and it is also difficult to achieve a balance between low frequency strength and low frequency dive, resulting in poor sound quality.

### BRIEF SUMMARY OF THE INVENTION

The technical problem to be solved by the present invention is to provide a loudspeaker with good sound quality.

In order to solve the above technical problem, the technical solution adopted by the present invention is a loudspeaker, including a support, a vibration system and a magnetic circuit assembly, wherein the vibration system includes a diaphragm, a passive diaphragm and a voice coil; the magnetic circuit assembly includes an inner magnetic ring and an outer magnetic ring; the periphery of the diaphragm is fixed at the top of the support; the voice coil is suspended below the diaphragm and located in a magnetic gap between the inner magnetic ring and the outer magnetic ring; a space between the diaphragm and the magnetic circuit assembly forms a vibration cavity; the support has an annular structure; the periphery of the passive diaphragm is fixed at the bottom of the support, and a space between the passive diaphragm and the magnetic circuit assembly forms a resonance cavity; the magnetic circuit assembly includes a via hole, and the resonance cavity is connected with the vibration cavity through the via hole.

In the loudspeaker described above, the via hole is located at the center of the inner magnetic ring.

The loudspeaker described above includes a damping screen, an annular rear adjustment plate and an annular PCB, the periphery of the passive diaphragm is fixed on a top surface of the rear adjustment plate, and the PCB is fixed on a bottom surface of the rear adjustment plate; the periphery of the rear adjustment plate is fixed at the bottom of the support; a through hole is formed in the middle of the passive diaphragm, and the damping screen is installed on the through hole of the passive diaphragm.

The loudspeaker described above includes a damping screen, an annular rear adjustment plate and an annular PCB; the periphery of the passive diaphragm is fixed on an edge of an inner hole of the rear adjustment plate, and the PCB is fixed on a bottom surface of the rear adjustment plate; the periphery of the rear adjustment plate is fixed at the bottom of the support; a through hole is formed in the middle of the passive diaphragm, and the damping screen is installed on the through hole of the passive diaphragm.

The loudspeaker described above includes a damping screen, an annular rear adjustment plate and an annular PCB; the periphery of the passive diaphragm is fixed on an edge of an inner hole of the rear adjustment plate, and the PCB is fixed on a bottom surface of the rear adjustment plate; the periphery of the rear adjustment plate is fixed at the bottom of the support; the rear adjustment plate and the PCB include interconnected through holes, and the damping screen is installed on the through holes of the rear adjustment plate and the PCB.

In the loudspeaker described above, the inner hole of the annular rear adjustment plate is a stepped hole with a large top and a small bottom.

In the loudspeaker described above, an inner hole of the annular support is a stepped hole with a large top and a small bottom, a large hole of the stepped hole includes an annular bottom plate, and the annular bottom plate includes a plurality of damping holes which connect the vibration cavity with the outside.

The loudspeaker described above includes a damping screen and a C-shaped PCB, an inner hole of the support is a stepped hole with a large top and a small bottom, a large hole of the stepped hole includes an annular bottom plate, the C-shaped PCB is fixed on a bottom surface of the annular bottom plate of the support; the annular bottom plate includes a through hole that connects the vibration cavity with the outside, the through hole is arranged at an opening of the C-shaped PCB, and the damping screen is installed on the through hole of the annular base plate.

The loudspeaker described above includes a breathable protective cover installed above the diaphragm, and the periphery of the protective cover is fixed at the top of the annular support; a bottom surface of the periphery of the protective cover is pressed against an edge of the diaphragm.

The present invention adds a passive radiator to the traditional loudspeaker, forming an acoustic lever structure in a packaged support cavity, which greatly reduces the natural frequency f0 of a small-sized loudspeaker unit. In addition, low-frequency dual-phase output is achieved by one loudspeaker, which provides effective support for end products using the loudspeaker with this structure to restore a natural sound field

### BRIEF DESCRIPTION OF THE SEVERAL VIEWS OF THE DRAWINGS

The present invention will be further described in detail with reference to the accompanying drawings and specific embodiments.

FIG. 1 is an exploded view of a loudspeaker according to Embodiment 1 of the present invention.

FIG. 2 is a cross-sectional structural view of the loudspeaker according to Embodiment 1 of the present invention.

FIG. 3 is a cross-sectional structural view of a loudspeaker according to Embodiment 2 of the present invention.

FIG. 4 is a cross-sectional structural view of a loudspeaker according to Embodiment 3 of the present invention.

FIG. 5 is a cross-sectional structural view of a loudspeaker according to Embodiment 4 of the present invention.

FIG. 6 is a left view of a loudspeaker according to Embodiment 5 of the present invention.

FIG. 7 is a cross-sectional structural view of a loudspeaker according to Embodiment 6 of the present invention.

### DETAILED DESCRIPTION OF THE INVENTION

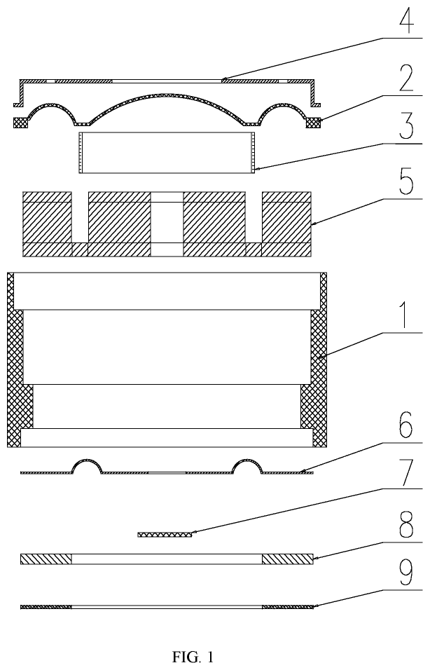

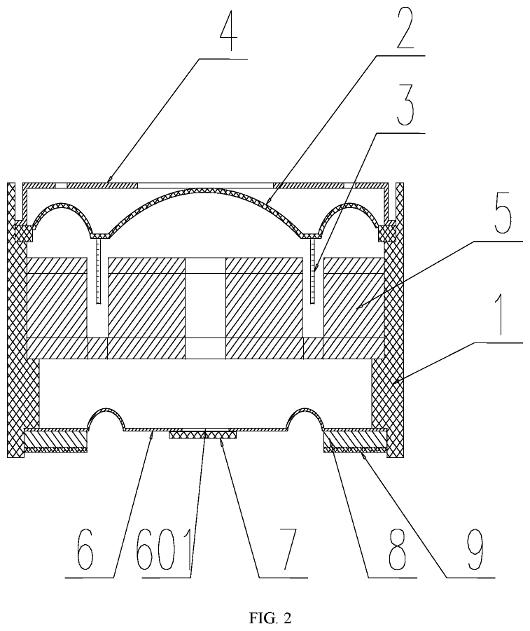

The structure of a loudspeaker with a passive radiator according to Embodiment 1 of the present invention, as shown in FIGS. 1 and 2, includes an annular support 1, a breathable protective cover 4, an annular rear adjustment plate 8, an annular PCB 9, a vibration system, and a magnetic circuit assembly 5.

The vibration system includes a diaphragm 2, a passive diaphragm 2 and a voice coil 3. The magnetic circuit assembly 5 is fixed in the middle of an inner hole of the support 1 and includes an inner magnetic ring and an outer magnetic ring. The bottom of the inner magnetic ring and the bottom of the outer magnetic ring are connected through a magnetic yoke, and a via hole is vertically formed in the center of the inner magnetic ring.

The periphery of the diaphragm 2 is fixed at the top of the support 1, the protective cover 4 is installed above the diaphragm 2, and the periphery of the protective cover 4 is fixed at the top of the annular support 1. A bottom surface of the periphery of the protective cover 4 is pressed against an edge of the diaphragm 2.

The voice coil 3 is suspended below the diaphragm 2, and a lower part of the voice coil 3 is located in a magnetic gap between the inner magnetic ring and the outer magnetic ring. A space between the diaphragm 2 and the magnetic circuit assembly 5 forms a vibration cavity. The periphery of the passive diaphragm 2 is fixed at the bottom of the support 1, and a space between the passive diaphragm 2 and the magnetic circuit assembly 5 forms a resonance cavity. The resonance cavity is connected with the vibration cavity through the via hole.

The periphery of the passive diaphragm 2 is fixed on a top surface of the rear adjustment plate 8, and the PCB 9 is fixed on a bottom surface of the rear adjustment plate 8. The periphery of the rear adjustment plate 8 is fixed on the bottom of the support 1. A through hole 601 is formed in the middle of the passive diaphragm 2, and a damping screen 7 is installed on the through hole 601 of the passive diaphragm 2.

The passive diaphragm 2, the rear adjustment plate 8 and the damping screen 7 in Embodiment 1 constitute the passive radiator in Embodiment 1.

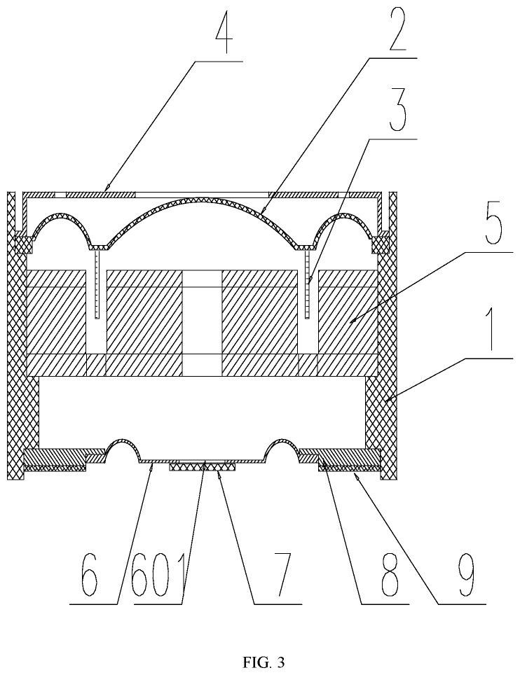

The structure of a loudspeaker with a passive radiator in Embodiment 2 of the present invention is shown in FIG. 3. Embodiment 2 slightly differs from Embodiment 1 only in the structure of the passive radiator. In Embodiment 2, the periphery of the passive diaphragm 2 is fixed on an edge of an inner hole of the rear adjustment plate 8, and the PCB 9 is fixed on the bottom surface of the rear adjustment plate 8. The periphery of the rear adjustment plate 8 is fixed on the bottom of the support 1.

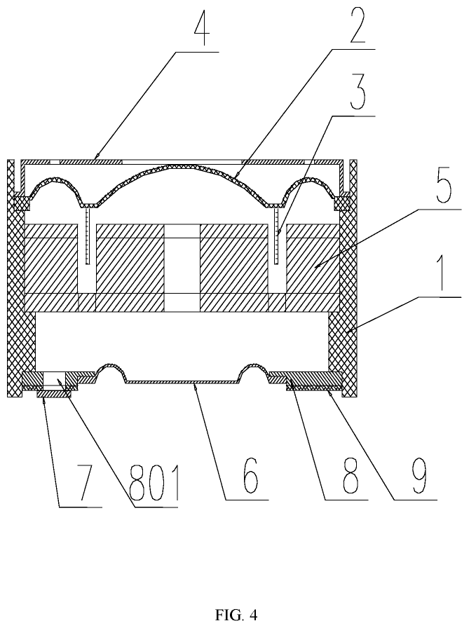

The structure of a loudspeaker with a passive radiator in Embodiment 3 of the present invention is shown in FIG. 4. Embodiment 3 slightly differs from Embodiment 1 only in the structure of the passive radiator. In Embodiment 3, the periphery of the passive diaphragm 2 is fixed on an edge of an inner hole of the rear adjustment plate 8, and the PCB 9 is fixed on the bottom surface of the rear adjustment plate 8. The periphery of the rear adjustment plate 8 is fixed on the bottom of the support 1. The rear adjustment plate 8 and the PCB 9 include interconnected through holes 801, and the damping screen 7 is installed on the through holes of the rear adjustment plate 8 and the PCB 9.

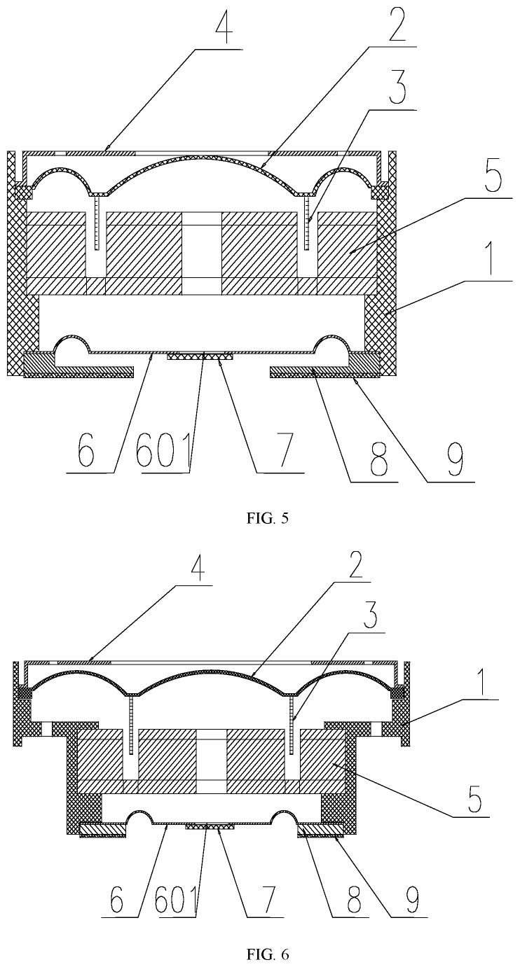

The structure of a loudspeaker with a passive radiator in Embodiment 4 of the present invention is shown in FIG. 5. Embodiment 4 slightly differs from Embodiment 1 only in the structure of the passive radiator. In Embodiment 3, the inner hole of the annular rear adjustment plate 8 is a stepped hole with a large top and a small bottom, and the periphery of the rear adjustment plate 8 is fixed on the bottom of the support 1. The periphery of the passive diaphragm 2 is fixed on a top surface of a large hole of the stepped hole of the rear adjustment plate 8, and the PCB 9 is fixed on the bottom surface of the rear adjustment plate 8. The diameter of the inner hole of the PCB 9 is the same as that of a small hole of the stepped hole of the rear adjustment plate 8.

The structure of a loudspeaker with a passive radiator in Embodiment 5 of the present invention is shown in FIG. 6. Embodiment 5 slightly differs from Embodiment 1 only in the structure of the support. In Embodiment 5, the annular support 1 has a T-shaped structure with a large top and a small bottom, the inner hole of the support 1 is a stepped hole with a large top and a small bottom, the large hole of the stepped hole includes an annular bottom plate, and the annular bottom plate is provided with a plurality of damping holes which connect the vibration cavity with the outside.

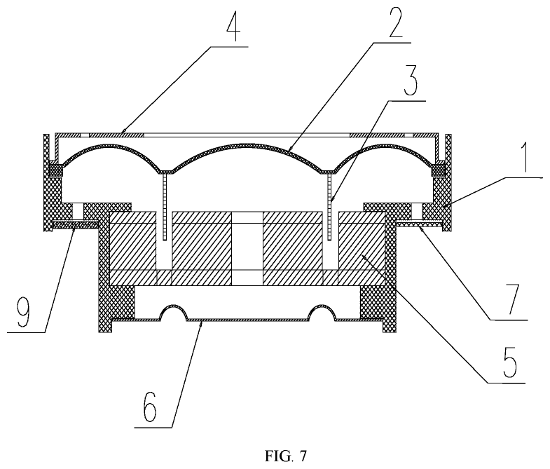

The structure of a loudspeaker with a passive radiator in Embodiment 6 of the present invention is shown in FIG. 7. Embodiment 6 mainly differs from Embodiment 1 in the structure of the passive radiator and the structure of the support. In Embodiment 6, the annular support 1 has a T-shaped structure with a large top and a small bottom, the inner hole of the support 1 is a stepped hole with a large top and a small bottom, the large hole of the stepped hole includes an annular bottom plate, and the PCB 9 is C-shaped and has an opening.

The C-shaped PCB 9 is fixed on an outer bottom surface of the annular bottom plate of the support 1. The annular bottom plate has a through hole that connects the vibration cavity with the outside, the through hole is arranged at the opening of the C-shaped PCB 9, and a damping screen 7 is installed on the through hole of the annular bottom plate.

In Embodiment 6, the periphery of the passive diaphragm 2 is directly fixed at the bottom of the support 1. The passive diaphragm 2 is an integral film without a through hole in the middle.

The loudspeaker in the above embodiments of the present invention, having an additional passive radiator relative to the traditional loudspeakers, achieves better acoustic performance and effectively increases the low-frequency response of the loudspeaker unit, which is beneficial to improving the performance of end products.

What is claimed is:

1. A loudspeaker, comprising a support, a vibration system and a magnetic circuit assembly, the vibration system comprising a diaphragm and a voice coil, the magnetic circuit assembly comprising an inner magnetic ring and an outer magnetic ring, a periphery of the diaphragm being fixed at a top of the support, and the voice coil being suspended below the diaphragm and located in a magnetic gap between the inner magnetic ring and the outer magnetic ring; a space between the diaphragm and the magnetic circuit assembly forming a vibration cavity; wherein the vibration system comprises a passive diaphragm, and the support has an annular structure; a periphery of the passive diaphragm is fixed at a bottom of the support, and a space between the passive diaphragm and the magnetic circuit assembly forms a resonance cavity; the magnetic circuit assembly comprises a via hole, and the resonance cavity is connected with the vibration cavity through the via hole.

2. The loudspeaker according to claim 1, wherein the via hole is located at a center of the inner magnetic ring.

3. The loudspeaker according to claim 1, comprising a damping screen, an annular rear adjustment plate and an annular PCB, wherein the periphery of the passive diaphragm is fixed on a top surface of the rear adjustment plate, and the PCB is fixed on a bottom surface of the rear adjustment plate; a periphery of the rear adjustment plate is fixed at the bottom of the support; a through hole is formed in a middle of the passive diaphragm, and the damping screen is installed on the through hole of the passive diaphragm.

4. The loudspeaker according to claim 1, comprising a damping screen, an annular rear adjustment plate and an annular PCB, wherein the periphery of the passive diaphragm is fixed on an edge of an inner hole of the rear adjustment plate, and the PCB is fixed on a bottom surface of the rear adjustment plate; a periphery of the rear adjustment plate is fixed at the bottom of the support; a through hole is formed in a middle of the passive diaphragm, and the damping screen is installed on the through hole of the passive diaphragm.

5. The loudspeaker according to claim 1, comprising a damping screen, an annular rear adjustment plate and an annular PCB, wherein the periphery of the passive diaphragm is fixed on an edge of an inner hole of the rear adjustment plate, and the PCB is fixed on a bottom surface of the rear adjustment plate; a periphery of the rear adjustment plate is fixed at the bottom of the support; the rear adjustment plate and the PCB include interconnected through holes, and the damping screen is installed on the through holes of the rear adjustment plate and the PCB.

6. The loudspeaker according to claim 3, wherein an inner hole of the annular rear adjustment plate is a stepped hole with a large top and a small bottom.

7. The loudspeaker according to claim 3, wherein an inner hole of the annular support is a stepped hole with a large top and a small bottom, a large hole of the stepped hole comprises an annular bottom plate, the annular bottom plate comprises a plurality of damping holes that connect the vibration cavity with the outside.

8. The loudspeaker according to claim 1, comprising a damping screen and a C-shaped PCB, wherein an inner hole of the support is a stepped hole with a large top and a small bottom, a large hole of the stepped hole comprises an annular bottom plate, the C-shaped PCB is fixed on a bottom surface of the annular bottom plate of the support; the annular bottom plate comprises a through hole that connects the vibration cavity with the outside, the through hole is arranged at an opening of the C-shaped PCB, and the damping screen is installed on the through hole of the annular base plate.

9. The loudspeaker according to claim 1, comprising a breathable protective cover installed above the diaphragm, wherein a periphery of the protective cover is fixed at the top of the annular support; a bottom surface of the periphery of the protective cover is pressed against an edge of the diaphragm.
